(19) United States
(12) Patent Application Publication
(10) Pub. No.: US 2021/0088671 A1
(43) Pub. Date: Mar. 25, 2021

(54) ANTENNA ARRAY SYSTEM FOR NAVIGATION SYSTEMS

(71) Applicants: Rheinisch-Westfälische Technische Hochschule (RWTH) Aachen, Aachen (DE); TECHNISCHE UNIVERSITÄT ILMENAU, Ilmenau (DE); DEUTSCHES ZENTRUM FÜR LUFT-UND RAUMFAHRT E.V. (DLR), Koln (DE)

(72) Inventors: Michael MEURER, Gilching (DE); Marius BRACHVOGEL, Aachen (DE); Matthias HEIN, Martinroda (DE); Ralf STEPHAN, Erfurt (DE); Michael WEBER, Munchen (DE)

(21) Appl. No.: 16/580,233

(22) Filed: Sep. 24, 2019

(51) Int. Cl. G01S 19/21; G01S 19/14; G01S 19/36; G01S 19/53

(52) U.S. Cl. CPC G01S 19/21; G01S 19/14; G01S 5/0063; G01S 19/53; G01S 19/36

(57) ABSTRACT

The invention pertains to an antenna array system for Navigation Systems comprising a set of receiving elements, each receiving element comprising at least one antenna or more antennas, the antennas being designed for receiving electro-magnetic signals of at least one certain wavelength, whereby at least two receiving elements of said set of receiving elements are located in distance to each other of at least said one certain wavelength, whereby the signals received by said receiving elements are processed by at least one signal processing unit to thereby determine a location related information.

### TECHNICAL FIELD

The invention pertains to an antenna system and methods to be used therewith, in particular to an antenna system of a satellite-based positioning system.

### BACKGROUND

In todays and future systems there will be a growing need for reliable and fast determination of location related information. Such information, without limitation, may be a position, a direction, a velocity, combinations thereof, or the like. In particular due to the aims to provide autonomous systems there is a high interest in providing position related information fast and reliable.

However, even though a growing need exists, there are certain boundaries to be met.

For example, Global Positioning Systems are operating with circular polarized signals. On the receiving end, where a location related information is to be determined, circular polarized signals are typically received by a two antennas arrangement (having perpendicular polarization) and a phase shifting element.

Bearing in mind that typical signals are transmitted at frequencies within the range of 1100 MHz to 1700 MHz, typical wavelengths are within a range of 17 cm to 27 cm.

These wavelengths also define physical properties of antenna intended for reception of these signals.

At the same time also other electronic systems and/or wireless transmission systems are emerging. These systems contribute to radio frequency interference. Radio Frequency interference (abbrev. RFI) may diminish the signal noise ratio in the receiver and may even impair the signals such that no proper reception may be performed.

With the increasing number of GNSS applications, the deliberate transmission of RFI, also known as jamming, has attracted attention in the past years, see e.g. M. Brachvogel, M. Niestroj, S. Zorn, M. Meurer, S. N. Hasnain, R. Stephan, M. A. Hein, “Performance of GNSS Beamforming Algorithms using Distributed Sub-arrays in Automotive Applications”, ION GNSS+2018, Miami/Fla., 2018, published 26 Sep. 2018, which is incorporated by reference.

At the same time, it is to be noted that reception of a satellite-based positioning signals itself is prone to errors because the power for transmission of these signals is low. To allow distinction of signals originating from different satellites a CDMA-based transmission scheme is employed. That is, the payload signal is multiplied with a random noise sequence unique for each satellite, allowing to use a same frequency by the satellites.

Because of the low radiated power interfering emission by other sources—even at low power—may lead to a situation that one, more or even all satellite signals which otherwise could have been received are no longer detectable. Even with the knowledge of the random noise sequences it may be that a recovery of signals is impossible.

To cope with this situation, it has been proposed in the past to provide filtering in different domains, in particular temporal, spectral and spatial domain. It is however known that filtering in temporal and spectral domain—while being adoptable without changes to the receiver itself—with respect to even a single antenna impair at the same time reception quality as well as precision of positioning data. For these reasons, spatial approaches gained more attention. Within spatial approaches, beam forming is employed allowing to superimpose signals of different antennas of an antenna system to thereby selectively attenuate or amplify certain spatial directions by destructive or constructive combination. Destructive superimposition is also known as “nulling”.

It has been proposed in the past to use antenna array systems to counteract radio frequency interference. Such antenna arrays allow for extending the degrees of freedom of RFI mitigation to the spatial domain using techniques such as beam steering or null steering, thereby facilitating the possibility to attenuate the direction of arrival (DOA) of an incident RFI. Additionally, the signal to noise ratio (SNR) of the satellite signals can be increased with the same approach.

Those techniques rely on an estimation of the DOA, which is evaluated over the relative phase delays, which an incident signal experiences following from the different positions of the radiating elements.

In order to avoid unwanted attenuation of desired signals or amplification of interfering signals respectively, care must be taken in the array design to avoid ambiguities in the array manifold. Therefore, the structure of conventional arrays is typically chosen as a grid structure, where the element spacing in each direction does not exceed half of a carrier wavelength, as for example a uniform rectangular array (URA). Hence, the optimum size of a square 2×2 URA is to a certain degree linked to the physical properties of the incident wave. This leads to array edge lengths of 20-25 cm for the GNSS frequency ranges of interest.

The size of an URA therefore impedes its application in the consumer automotive sector, where aesthetic design is of paramount importance and a hidden installation is required by the automotive OEMs.

For example, it has been proposed to use uniform rectangular arrays. These uniform rectangular arrays had to be spaced in a half-wavelength arrangement. However, in certain fields, such as automotive, such arrays did not meet aesthetic requirements as being too obvious. The spacing requirement was deemed necessary for the back then designs to cope with ambiguity which is otherwise introduced when the arrays are spaced further apart.

Starting from there, the inventors invented a new approach which is versatile and/or cost effective and/or allows for improved freedom.

### SUMMARY OF INVENTION

The inventors propose an antenna array system for Navigation Systems comprising a set of receiving elements, each receiving element comprising at least one antenna or more antennas, the antennas being designed for receiving electro-magnetic signals of at least one certain wavelength, whereby at least two receiving elements of said set of receiving elements are located in distance to each other of at least said one certain wavelength, whereby the signals received by said receiving elements are processed by at least one signal processing unit to thereby determine a location related information.

The inventors also propose methods for purposeful use of said antenna array system.

### BRIEF DESCRIPTION OF THE FIGURES

The exemplary embodiments of the invention will be described in detail, with reference to the following figures. It should be understood that the drawings are not necessarily shown to scale. In certain instances, details which are not necessary for an understanding of the invention or which render other details difficult to perceive may have been omitted. It should be understood, of course, that the invention is not necessarily limited to the particular embodiments illustrated herein.

FIG. 1a-1d shows schematically certain arrangements of receiving elements to be used in embodiments of the invention,

FIG. 2 shows schematically an arrangement of receiving elements according to an aspect of the invention,

FIG. 3 shows schematically a logical arrangement of elements according to another aspect of the invention,

FIG. 4 shows schematically a logical arrangement of elements according to a further aspect of the invention,

FIG. 5 shows schematically a logical arrangement of elements according to still another aspect of the invention,

FIG. 6 shows schematically a detail of aspects according to embodiments of the invention,

FIG. 7 shows a signal model used to describe an aspect of signal processing according to an aspect of the invention,

FIG. 8 shows schematically a block diagram of an antenna system arrangement as described in context of FIG. 7,

FIG. 9 shows a signal model used to describe another aspect of signal processing according to an aspect of the invention,

FIG. 10 shows schematically a block diagram of an antenna system arrangement as described in context of FIG. 9,

FIG. 11 shows a possible implementation of a delay compensation according to an aspect of the invention, and

FIG. 12 shows a possible arrangement of receiving elements in connection with a vehicle according to another aspect of the invention.

### DETAILED DESCRIPTION

The exemplary embodiments of this invention will be described in relation to processing and interpretation of data, and in particular seismic data. The exemplary systems and methods of this invention will also be described in relation to seismic data interpretation and manipulation. However, to avoid unnecessarily obscuring the present invention, the following description omits well-known structures and devices that may be shown in block diagram form or otherwise summarized.

For purposes of explanation, numerous details are set forth in order to provide a thorough understanding of the present invention. However, it should be appreciated that the present invention may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a communications network and/or the Internet, or within a dedicated secure, unsecured and/or encrypted system. Thus, it should be appreciated that the components of the system can be combined into one or more devices or collocated on a particular node of a distributed network, such as a communications network. As will be appreciated from the following description, and for reasons of computational efficiency, the components of the system can be arranged at any location within a distributed network without affecting the operation of the system.

Furthermore, it should be appreciated that various links can be used to connect the elements and can be wired or wireless links, or any combination thereof, or any other known or later developed element(s) that is capable of supplying and/or communicating data to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique, including those performed by a system, such as a processor, an expert system or neural network.

The term “automatic” and variations thereof, as used herein, refers to any process or operation done without material human input when the process or operation is performed. However, a process or operation can be automatic even if performance of the process or operation uses human input, whether material or immaterial, received before performance of the process or operation. Human input is deemed to be material if such input influences how the process or operation will be performed. Human input that consents to the performance of the process or operation is not deemed to be “material”.

The terms “determine”, “calculate” and “compute,” and variations thereof, as used herein, are used interchangeably and include any type of methodology, process, mathematical operation or technique.

Any method step may be embodied in software or software enabled hardware or hardware.

The term processing unit may refer to any kind of microprocessor, microcontroller, digital signal processing unit, Field-programmable-gate Array, or application specific integrated circuit.

The term “module” as used herein refers to any known or later developed hardware, software, firmware, artificial intelligence, fuzzy logic, or combination of hardware and software that is capable of performing the functionality associated with that element. Also, while the invention is described in terms of exemplary embodiments, it should be appreciated that individual aspects of the invention can be separately claimed.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

Additionally, all references identified herein are incorporated herein by reference in their entirely.

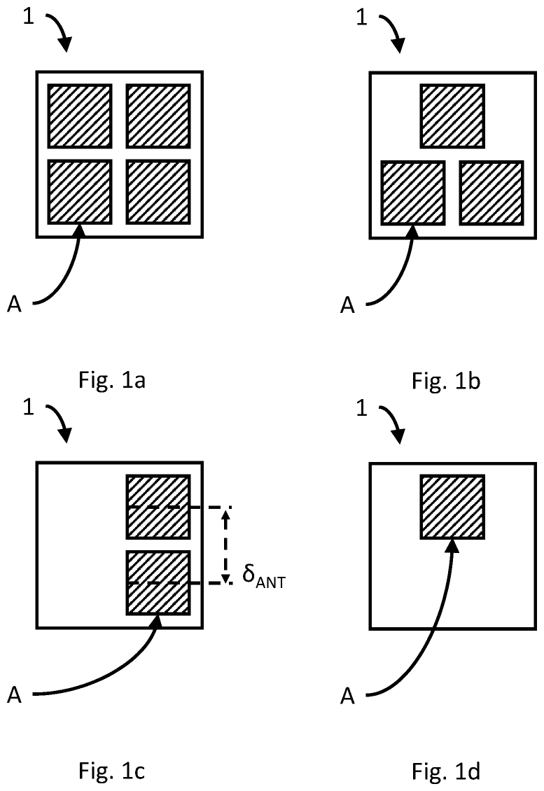

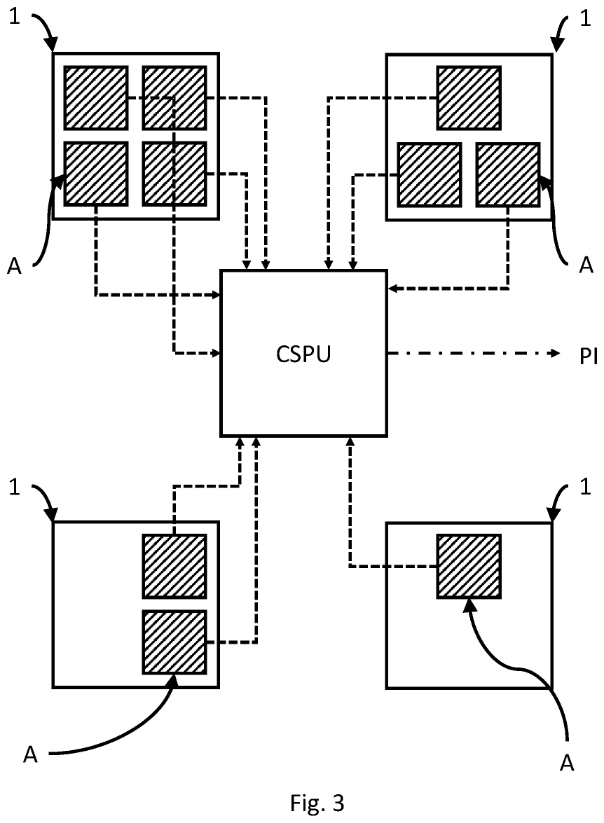

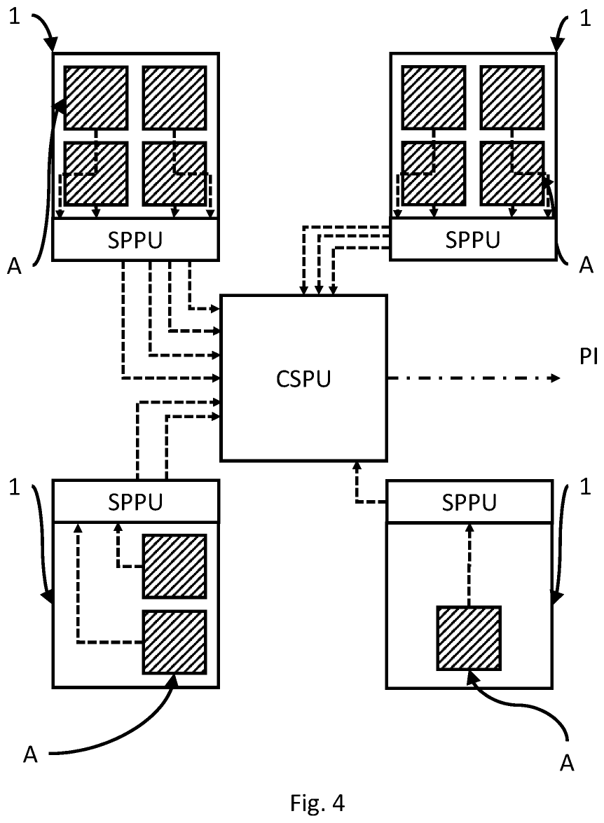

In the following we well refer to receiving elements. A receiving element according to the invention may be in general an array of several antennas or may even be a single antenna. For example, FIG. 1a shows a receiving element 1 comprising 4 antennas A, FIG. 1b shows a receiving element 1 comprising 3 antennas, FIG. 3 shows a receiving element 1 comprising 2 antennas, while FIG. 4 shows a receiving element 1 comprising a single antenna. It is to be known that even though FIGS. 1a-1c suggest a regular arrangement of antennas A with a receiving element 1, such regular arrangement is not necessary. However, we will assume that the distance of adjacent antennas A within a receiving element 1 is equal or less half of a wavelength of a signal to be received for the purpose of the system. It is also to be mentioned that the outline of the antennas A shown may be different and does not necessarily require a rectangular/square arrangement, e.g. a uniform rectangular array.

An antenna array system according to the invention comprises a set of receiving elements 1, i.e. at least 2 receiving elements. The receiving elements 1 of such a system may be different. I.e. the antenna array system may comprise a receiving element according to FIG. 1a and another receiving element according to FIG. 1d. Likewise an antenna system according to the invention may comprise 4 receiving elements 1 according to FIG. 1c. This allows for adaptable solutions according to the needs.

In the following we will detail conditions allowing for an unambiguous estimation of spatial incidence of a signal. Unambiguous in this context is meat to describe that differential amplitude- and phase information of an incident signal may be attributed to a particular direction with respect to the hemisphere.

If at least one of the receiving elements 1 of an antenna system is arranged according to FIG. 1a or 1b, i.e. provides a two-dimensional arrangement of antennas within the receiving element 1 an unambiguous estimation of spatial incidence of a signal may always be performed, irrespective of other receiving elements.

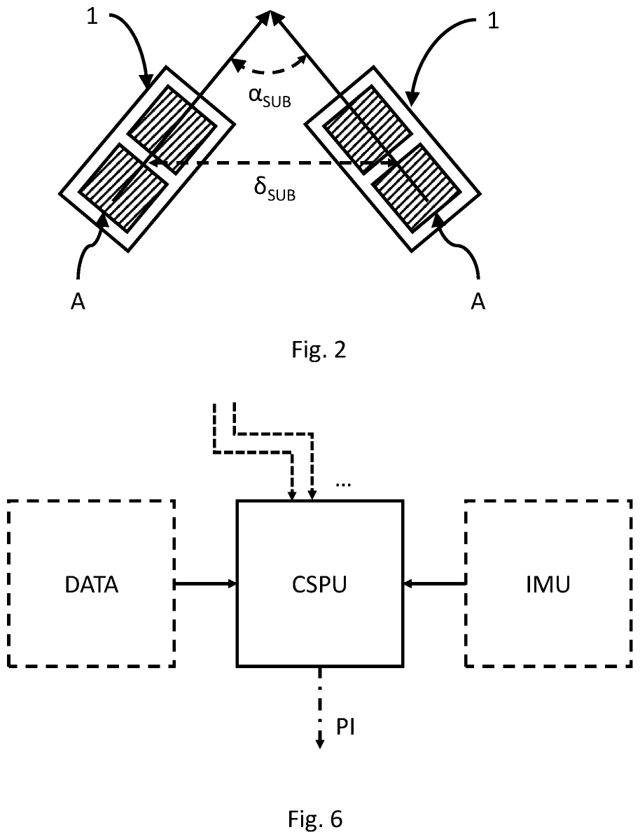

If no receiving elements according to FIG. 1a or 1b are present within an antenna array system, then one may provide at least two receiving elements 1 according to FIG. 1c. These receiving elements 1 shall be arranged according to FIG. 2. Within such an antenna array system these two receiving elements shall be arranged such that the distance δ_{sub} is small. An increasing distance leads to a diminishing correlation of signals and may also impair reception quality because of the resulting pattern. Furthermore, these two receiving elements shall be arranged such that the angle α_{sub} is close to 90°. In a preferred embodiment the angle α_{sub} is within the range of 70°-110°. If the receiving elements are arranged such that the directions thereof are close to parallel this will also impair reception quality.

Details with respect to ambiguities and their handling may be found in “Performance of GNSS Beamforming Algorithms using Distributed Sub-arrays in Automotive Applications”, 31st International Technical Meeting of the Satellite Division of the Institute of Navigation (ION GNSS+ 2018), Miami, Fla., Sep. 24-28, 2018.

But even in case of an antenna system having only two receiving elements 1 according to FIG. 1d the system described in the following may provide location related information.

We will now turn to other aspects of the antenna array system according to embodiments of the invention. It is to be emphasized that further elements such as passive filters, delay lines, matching networks, etc. may be present as well. Furthermore, at some stage amplifiers, such as low noise amplifiers and/or mixers may be present as well. While it is understood that they operate on signals leading to amplified representations and representations on a different frequency, they are held to be representing the signal itself.

While in the following discussion with respect to FIGS. 3 to 5 a mix of receiving elements 1 is shown within an antenna array system, the invention is not limited to this mix but may have at least two receiving elements 1 according to one or more configuration as shown in FIGS. 1a to 1d.

Within such a system neighboring receiving elements 1 are processed.

In the arrangement shown in FIG. 3 each receiving element, respectively each antenna thereof, provides its raw data, i.e. a received signal, towards a (centralized) signal processing unit CSPU via a respective high frequency connection. These raw signals are shown as dashed lines in FIG. 3.

The signal processing unit CSPU may be a specialized processing unit such as a digital signal processing unit, a microprocessor, a microcontroller, an ASIC or an FPGA.

Within the (centralized) signal processing unit CSPU these (raw) signals are processed. The CSPU may perform an interference mitigation (noise reduction) and may increase the signal-to-noise-ration of the signals as will be described in the following.

The resulting Platform Information may be of different kind. It may be the position information of the antenna array system itself or the position of a receiving element 1 of the antenna system, a velocity of the antenna array system, a rotational speed of the antenna array system, estimation of a direction of arrival of a satellite signal, estimation of a direction of arrival of a jamming signal.

We will refer to this arrangement as uncalibrated arrangement.

In such an uncalibrated arrangement one may process the signals as will be described below.

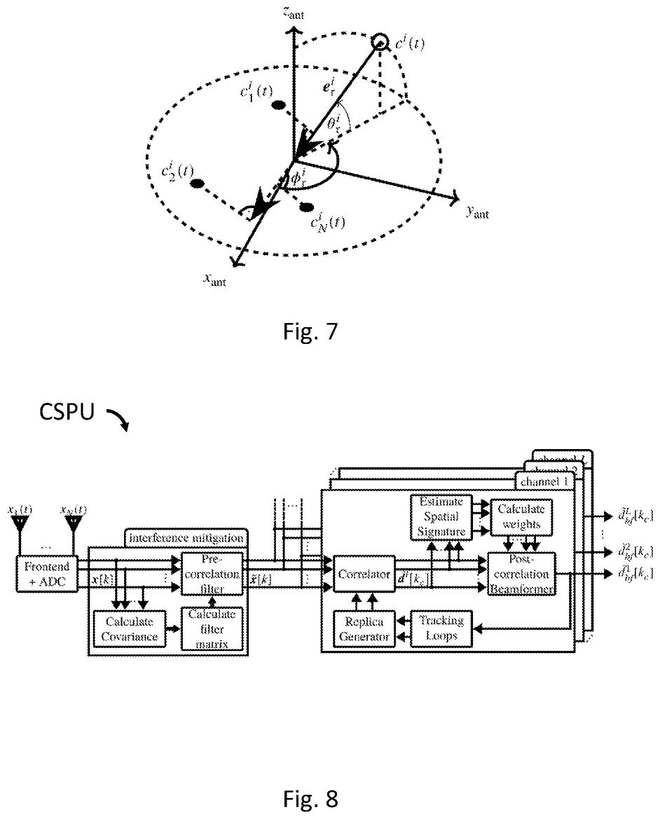

In FIG. 7 a coordinate system, normalized wave vector and relative delays to the origin for a narrowband source signal is shown. The incident signal of source i (satellite) is shown in FIG. 7 as cⁱ(t).

cⁱ(t)=xⁱ(t)=bⁱ(t)·e^{j2πf}^{ⁱ}^{t}

thereby describes a signal on a carrier frequency fⁱ and a baseband-signal b(t). Due to different position of the receiving elements 1 such signal is received by the receiving elements with different delay

$${x}^{i} ( t ) = ( \begin{matrix}{x}_{1}^{i} ( t - {τ}_{1}^{i} ) \\ ⋮ \\ {x}_{N}^{i} ( t - {τ}_{N}^{i} )\end{matrix} )$$

whereby N denotes the number of receiving elements 1. In case of the carrier signal the delay τₙⁱ may be denoted as phase shift, such that xⁱ(t) by means of a wave vector

$$k ( {φ}^{i} , {θ}^{i} ) = - \frac{2 π {f}^{i}}{c} ( \begin{matrix}cos {φ}^{i} \cdot cos {θ}^{i} \\ sin {φ}^{i} \cdot cos {θ}^{i} \\ sin {θ}^{i}\end{matrix} )$$

describing the direction of arrival in Azimuth—ϕⁱ and Elevation angel θⁱ, may be described as

$${x}^{i} ( t ) = ( \begin{matrix}{b}_{1}^{i} ( t - {τ}_{1}^{i} ) \\ ⋮ \\ {b}_{N}^{i} ( t - {τ}_{N}^{i} )\end{matrix} ) ⊙ ( \begin{matrix}{e}^{- jk ( {φ}^{i} , {θ}^{i} ) \cdot {r}_{1}} \\ ⋮ \\ {e}^{- jk ( {φ}^{i} , {θ}^{i} ) \cdot {r}_{N}}\end{matrix} ) \cdot {e}^{j 2 π {f}^{i} t}$$

The second term in the above equation is also known as steering vector. By means of a steering vector it is possible when determining phase differences of a signal received by different receiving elements using the pre-known antenna positions r₁ . . . r_{N} to determine a direction of arrival of the signal.

This theoretical approach however does not reflect certain inaccuracy in phase introduced by real-life systems such as those introduced by the receiver. These inaccuracies may be reflected by another term:

$${x}^{i} ( t ) = ( \begin{matrix}{b}_{1}^{i} ( t - {τ}_{1}^{i} ) \\ ⋮ \\ {b}_{1}^{i} ( t - {τ}_{N}^{i} )\end{matrix} ) ⊙ ( \begin{matrix}{γ}_{1}^{i} \cdot {e}^{j {ϱ}_{1}^{i}} \\ ⋮ \\ {γ}_{N}^{i} \cdot {e}^{j {ϱ}_{N}^{i}}\end{matrix} ) ⊙ ( \begin{matrix}{e}^{- jk ( {φ}^{i} , {θ}^{i} ) \cdot {r}_{1}} \\ ⋮ \\ {e}^{- jk ( {φ}^{i} , {θ}^{i} ) \cdot {r}_{N}}\end{matrix} ) \cdot {e}^{j 2 π {f}^{i} t} = ( \begin{matrix}{b}_{1}^{i} ( t - {τ}_{1}^{i} ) \\ ⋮ \\ {b}_{N}^{i} ( t - {τ}_{N}^{i} )\end{matrix} ) ⊙ ( \begin{matrix}{γ}_{1}^{i} \cdot {e}^{- j {Ω}_{1}^{i}} \\ ⋮ \\ {γ}_{1}^{i} \cdot {e}^{- j {Ω}_{N}^{i}}\end{matrix} ) \cdot {e}^{j 2 π {f}^{i} t}$$

Due to impacts on amplitude—γₙⁱ and impacts on phase [symbol] ₙⁱ, which are specific per receiving element 1, a meaningful estimation of a direction of arrival of a signal may not be performed straight away due to the superimposed determined phases Ω₁ⁱ bis Ωₙⁱ.

However, by use of an appropriate calibration scheme, these inaccuracies may be estimated and based on the estimation the inaccuracies may be computationally eliminated/reduced.

In the following we will show a signal processing with respect to FIG. 8 showing a beamforming method for usage within an antenna system according to the invention in case of an uncalibrated arrangement.

In this case we assume that the (raw) signals received the (centralized) signal processing unit CSPU are uncalibrated, i.e. differential amplitude and phase information are due to the separation of receiving elements 1 as well as the receiver itself. The receiver itself e.g., introduces such variances by means of differing cable lengths, differing electrical components, coupling, non-linear amplification, etc. In such a situation—as highlighted above—a proper estimation on basis of incident in a straight forward manner is not possible.

However, in the following we will present a realization of a (centralized) signal processing unit CSPU—e.g. as shown in FIG. 8—respectively method steps performed by said signal processing unit. The realization allows for a combined interference mitigation and improved Signal-to-noise-Ratio of the incident satellite signals.

In a first step raw data may be subject to amplification and/or mixing/(down-) converting and/or demodulation. Such step may be arranged within a frontend. The signals may then be subjected to quantization by an Analog/Digital/Converter ADC.

The now quantized raw-data of the respective receiving elements 1 may be demoted as

$$x [ k ] = ( \begin{matrix}{x}_{1} [ k ] \\ … \\ {x}_{N} [ k ]\end{matrix} )$$

whereby N reflects the number of receiving elements 1. The quantized raw-data may then be subjected to an interference mitigation which may be understood as a noise reduction step. The aim of this step is to reduce the influence of possible sources other than the satellite signals. A possible method is a so-called Prewhitening described in the following.

The interference mitigation makes use of the situation that the wanted signals are of low energy. Therefore, a spatial covariance matrix Rₓₓ of the quantized raw-data may be calculated with respect to a predetermined period.

In case of interference-free operation the signals of the receiving elements 1 are uncorrelated, since the power of the received signals is well below the thermal noise floor of the receiving elements 1 themselves. That leads to a situation in which the covariance matrix Rₓₓ resembles closely a diagonal matrix. However, in case of interference by one or more sources, a significant correlation may be detected. Hence, an attenuation of these interfering signals(s) may be achieved by decorrelation. To achieve this goal, one may determine a (weighted) inverse matrix P of Rₓₓ which is then operated on the received signal vector.

$$P = \frac{1}{S} \cdot {R}_{xx}^{- ω}$$

Within the formula, S is an (arbitrary) weighting coefficient, co denotes a power of Inversion. In case of Prewhitening ω=½.

The “improved” signal achieved by this operation is calculated as follows:

\tilde{x}[k]=P·x[k]

In a further step within the (centralized) signal processing unit CSPU the (improved) signals are subjected to correlation with satellite-specific Pseudo-Random-Noise Sequences. These correlated signals are superimposed by an appropriate beamforming algorithm within a Post-correlation Beamformer to thereby enhance the signal-to-noise-ratio of the satellite signals.

Such task may be performed by a so-called “Eigenbeamformer”. A possible implementation thereof is described in the following. By demodulation with a single carrier representation used identical for each signal originating from a respective receiving element 1 phase differences for these signals are maintained.

Therefore, in the manner as described above with respect to the quantized signals a correction may be made by again estimating a covariance matrix.

E.g. a covariance matrix \tilde{d}^{l}[k_{c}] with respect to the output of the correlation of the lth received satellite is estimated by the correlator. Thereafter the matrix is subjected to an eigenvalue-decomposition thereby providing the eigenvalues as well as the respective eigenvectors.

The eigenvector

$$α = ( \begin{matrix}{γ}_{1}^{l} \cdot {e}^{- j {Ω}_{1}^{l}} \\ ⋮ \\ {γ}_{N}^{l} \cdot {e}^{- j {Ω}_{N}^{l}}\end{matrix} )$$

corresponding to the largest eigenvalue, thereby denotes the amplitudes γₙⁱ und phases Ωₙⁱ of the incident l^{th} satellite signal at the n^{th} receiving element, whereby it is assumed that the signals are received in a direct line of sight.

Due to a missing calibration the differential phase information denotes the superimposed variances due to the spatial separation of the receiving elements 1 and the receiver.

To improve this situation, the eigenvector corresponding to the largest eigenvalue may be inverted and operated onto the covariance matrix \tilde{d}^{l}[k_{c}], so that the combined beam-shaped signal may be denoted as:

\tilde{d}_{bf}^{l}[k_{c}]=a^{H}(ϕ^{l},θ^{l})·\tilde{d}^{l}[k_{c}]

The combined beam-shaped signal may then be processed as a normal data stream as in any conventional positioning system to determine a satellite orbit and after determination of other satellite orbits subsequent determination of position of the antenna array system itself, its velocity, its angular velocity, . . . .

The configuration of FIG. 3 may be enhanced as shown in FIG. 4.

In the arrangement shown in FIG. 4 again each receiving element 1, respectively each antenna thereof, provides its raw data, i.e. a received signal, towards a (centralized) signal processing unit CSPU via a respective high frequency connection. These raw signals are shown as dashed lines in FIG. 4. However, in this embodiment signal pre-processing units SPPU are arranged close by/adjacent to the receiving elements 1.

The signal pre-processing units SPPUs, which may be present at least at two receiving elements 1, superimpose in an additive manner the raw signals with a further known signal.

The power level of this further signal is set to be below typical interreference signals to thereby avoid that the signal is canceled in the interference mitigation step because of being falsely held to be an interference signal. In the following we will refer to these combined signals as extended raw signal.

The signal pre-processing unit SPPU may be a specialized processing unit such as a digital signal processing unit, a microprocessor, a microcontroller, an ASIC or an FPGA.

As discussed previously with respect to FIG. 3 the extended raw signals are quantized in an Analog/Digital/Converter ADC.

However, based on the knowledge of the further known signal one may now determine amplitude and phase differences experienced on the way from the SPPU towards the quantization. The information thereof may be used to calibrate. That is, if the internal differences of the antenna array systems are known, the remaining differences are due to the spatial distribution of the receiving elements 1 within the antenna array system.

The resulting Platform Information may be of different kind. It may be the position information of the antenna array system itself or the position of a receiving element 1 of the antenna system, a velocity of the antenna array system, a rotational speed of the antenna array system, estimation of a direction of arrival of a satellite signal, estimation of a direction of arrival of a jamming signal.

We will refer to this arrangement as calibrated arrangement.

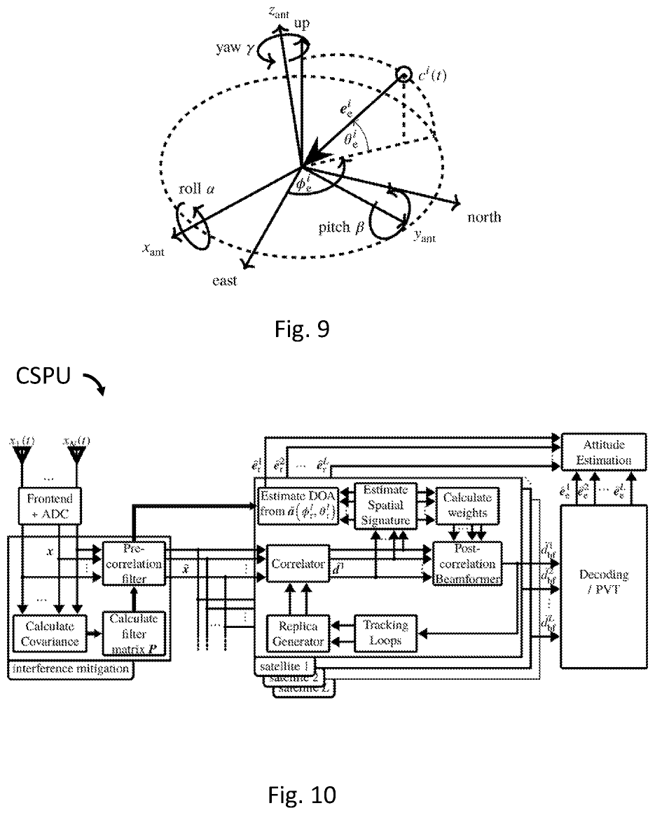

In such a calibrated arrangement one may process the signals as will be described below in connection with FIGS. 9 and 10.

In these calibrated cases one is no longer bound to perform a blind processing as described before with respect FIG. 3. The remaining phase differences of the respective channels of the receiving elements 1 may be determined by modelling with the steering vector after correlation of the spatial information of the l^{th} satellite signal. The steering vector is derived by means of the wave vector

$$k ( {φ}^{l} , {θ}^{l} ) = - \frac{2 π {f}^{l}}{c} ( \begin{matrix}cos {φ}^{l} \cdot cos {θ}^{l} \\ sin {φ}^{l} \cdot cos {θ}^{l} \\ sin {θ}^{l}\end{matrix} )$$

whereby f^{l} is the carrier frequency, c is the propagation speed of the incident signal and ϕ^{l} and θ^{l} describe a spatial information in azimuth—respectively elevation angle.

The spatial information may be estimated based on a measured delay of the incident signal in between the respective channels of said receiving elements 1.

Therefore, the scheme of FIG. 8 may be enhanced by a respective block for estimating a direction of arrival (DOA) as shown in FIG. 10.

An appropriate algorithm for estimation of a direction of arrival may be based on a MUltiple Signal Classification approach. By the algorithm for estimation of a direction of arrival the direction of arrival of a satellite signal may be estimated in the coordinate system of the receiving elements, see FIG. 9. A respective unit vector êᵣ^{l}, denoting a direction from the antenna array system towards said satellite l (or vice versa) may be derived.

The information may be used to estimate the position of the antenna area system in a known manner. Thereafter the direction of arrival may be used as a comparison within a local east-north-up-coordinate system and a unit vectors êₑ^{l} pointing from the estimated position of the array system to the satellite positions may be determined.

The phase differences within the receivers are related to the coordinate-system of the antenna. The momentary orientation thereof may be described with respect to the 3 orientational angles yaw γ, pitch β and roll α relative to the local east-north-up-coordinate-system (as shown in FIG. 9) and may be described as rotational matrix

êᵣ^{l}(\hat{ϕ}ᵣ^{l},\hat{θ}ᵣ^{l})=T(γ,β,α)·êₑ^{l}(\hat{ϕ}ₑ^{l},\hat{θ}ₑ^{l})

By choosing an appropriate algorithm for detection of the orientation (see e.g. Meurer, M. et al—Direction-of-Arrival Assisted Sequential Spoofing Detection and Mitigation (ION ITM 2016)) the rotational matrix and thereby the orientation of the antenna array system in spatial dimension may be determined.

Again, the same principle used before may be used in later stages of signal processing, e.g. beamforming, to determine possible directions of arrival of interfering signals. To allow for such processing the number of interfering signals sources needs to be estimated. Again, such estimation may be performed on basis of eigenvalues of the covariance matrix. Once eigenvalues of interfering signals are determined the respective eigenvectors may be used for determination of a direction of an interfering signal.

It is to be noted that increasing delays (τₙⁱ) in-between the channels from the receiving elements 1 lead to a loss in correlation. This may impair interference mitigation as well as signal improvement.

However, in case of a calibrated arrangement the direction of arrival in coordinates of the antenna system and therefrom a delay in-between the different channels may be estimated. The estimated delay may be used of compensation. Such compensation may be achieved by introducing additional delays, e.g. delay lines etc., to thereby approximate the delays.

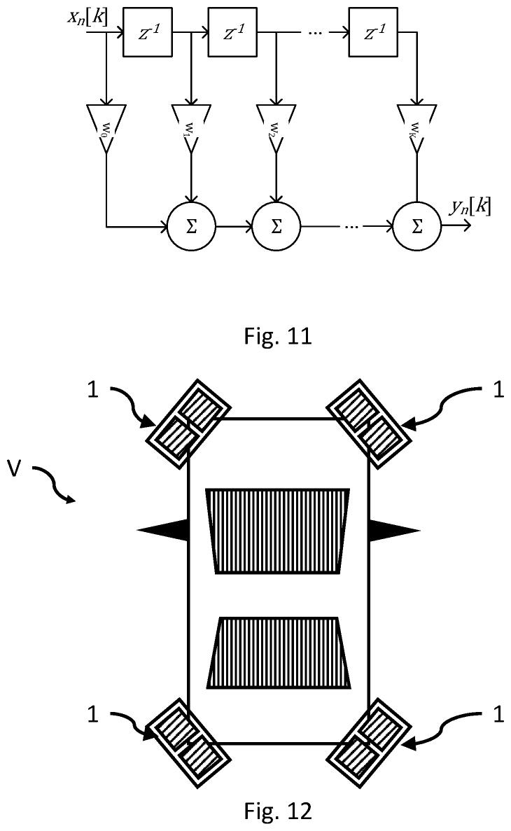

For such purposes adjustable FIR filter of length K as shown in FIG. 11 may be used in further embodiments of the invention. Likewise, such operation may be used to reduce noise. It is however to be taken into account that such compensation may allow for a benefit for one signal while it may at the same time be detrimental to other signals. Therefore, such FIR filters may be of particular when there is only a single interfering signal source or in the beamforming context where there should be only one dominant satellite signal to be processed.

Another possibility within interference mitigation is a so-called STAP method, see e.g. Perez Marcos, E. et al.—STAP as a Solution for Hardware Imperfections in Multi-Antenna GNSS Receivers (NAVITEC 2016). There a filtering like in FIG. 11 is employed on each receiving channel. Weighing factors are based on consecutive observations of the covariance matrix Rₓₓ. That is, the STAP algorithm provides for a linear Modification of a signal taking into account previous values.

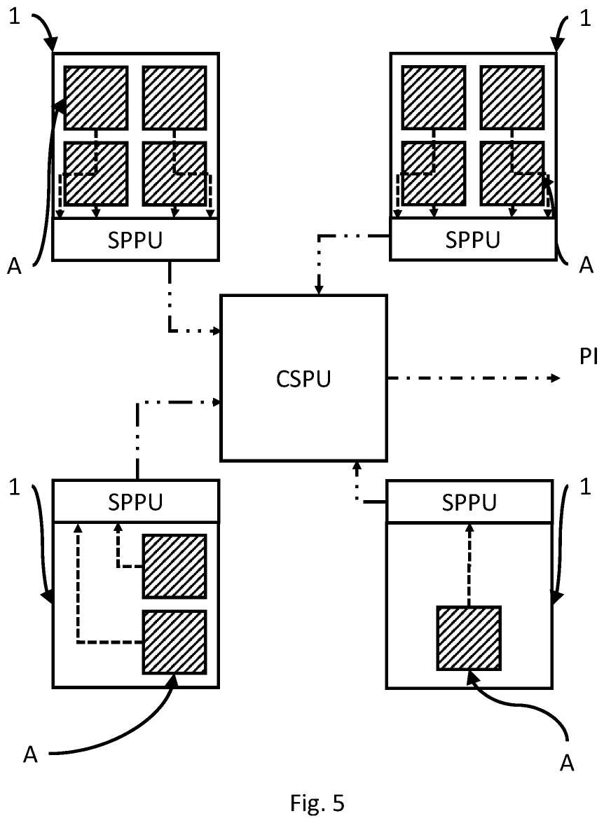

The configuration of FIG. 4 may be enhanced as shown in FIG. 5.

There the signal pre-processing unit SPPU may offer alternatively or additionally a preprocessing of raw signals of a respective receiving element 1.

A first possibility is that in case a receiving element 1 comprises more than one antenna A (i.e. see FIG. 1a-1c) raw signals of different antennas are combined before being directed towards the (centralized) signal processing unit CSPU. The signals may be combined e.g. by adjustable phase shifter and amplitude controller. The adaption may be controlled by the CSPU.

Another (alternative or additional) possibility is to integrate the frontend capabilities, i.e. including Analog/Digital-conversion ADC into the SPPUs. In that case instead of analogue (extended) raw signals digital signals may be transported towards the CSPU. In that case dedicated interfaces may be provided or existing interfaces, such as a CAN-Bus in a vehicle, may be (re-) used.

In order to allow for a synchronized processing within the CSPU, a time stamp may be associated by each SPPU before forwarding them to the CSPU. Processing may then be performed as described with respect to FIG. 4.

Another possibility is that the SPPU may subject the quantized signals of the antennas A of a receiving element 1 a two-stage beamforming process as detailed above in connection with FIG. 8. Thereby interfering signals may be suppressed and the Signal-to-noise ration of the target signal may be improved. Also, a position of the receiving element 1 may be determined. That is the data signal forwarded to the CSPU may comprise a position data of the receiving element 1 and preferably also a time data as outlined above. Additional data observed by the receiving element 1 such as GNSS observables may be transmitted as well.

Planar receiving elements, which by nature of their structure allow to estimate the orientation of incident signals may also provide this information towards the CSPU. The CSPU may due to the knowledge of relative positioning of the receiving elements combine the information received by the various receiving elements 1 and thereby determine a scalar position within the antenna array system. If information relating to a direction of arrival is present by at least one receiving element 1 this may be used for estimation of the spatial position of the antenna array system respectively an interfering signal source.

In further embodiments additional data sources may provide data towards the CSPU. For example, other sensors, e.g., Radar or Lidar sensors used in automotive, acceleration sensors, magnetometers . . . .

In some vehicles such information is present in a so-called inertial measurement unit IMU. The inertial measurement unit IMU is an electronic device that measures and reports a body's specific force, angular rate, and sometimes the orientation of the body, using a combination of accelerometers, gyroscopes, and sometimes magnetometers. IMUs are typically used to maneuver aircraft (an attitude and heading reference system), including unmanned aerial vehicles (UAVs), among many others, and spacecraft, including satellites and landers.

The invention is not limited to satellite-based positioning systems also known as global navigation satellite system (GNSS). However, the invention is of particular value for such global navigation satellite system (GNSS), in particular with respect to Naystar GPS, Glonass, Galileo, BeiDou, Quasi-Zenith. However, also regional systems such as NAVIC may benefit from the invention.

The invention as such may be used with any kind of vehicle.

In particular the invention may be used in ground vehicles such as cars, vans, lorries, motorbikes, scooter, agricultural engines, transporting vehicles in industry. For example, the invention may be used in a manner that receiving elements are located in or more bumper and/or rearview mirrors of a vehicle.

The invention may also be used in an aircraft or a water-based vehicle such as a ship or a vessel.

The invention shows that within an antenna system according to embodiments of the invention receiving elements may be distributed as sub-arrays with respect to a vehicle, such as a car as shown in FIG. 12 and thereby allows to overcome the limitation of half-wave spacing thereby allowing to decrease the size of individual receiving elements such that they could be arranged more easily at appropriate locations without interfering aesthetic requirements imposing mounting space limits. E.g. in FIG. 12 a first set of receiving elements may be positioned in/on a front bumper (shown at top of FIG. 12) while another set of receiving elements may be positioned in/on rearview mirrors (shown as black triangles at the side of the vehicle shown in FIG. 12) and/or in/on a front bumper. Obviously, the receiving elements in/on a front bumper may span a mathematical plane while the receiving elements in/on a rear bumper may span another mathematical plane. I.e. the planes may coincide but there is no necessity therefore. As described with respect to FIG. 2, the receiving elements may be spaced apart at a distance of 5 time the wavelength and more. Also, a direction of a first receiving element and a direction of a second receiving element may form an angle of more than 0° and less than 180°, preferably within the range of 70°-110°.

By use of the antenna system according to the invention respectively the methods it is possible to avoid the detrimental consequences of ambiguities due to the larger spacing and to allow for exploiting distributed receiving elements for robust satellite navigation

It is to be understood that it is not necessary to visible place the receiving elements but the location itself must be “visible” within the spectrum used for receiving signals.

That is, the invention does not only allow to meet aesthetic preferences but also to provide antennas at locations which are less prominent to be targeted by noise, e.g. noise generated on or by the vehicle itself. E.g., in aircrafts as well as ships transmitters for data transmission/two-way radio/radar purposes may interfere. Hence, it is now possible to arrange receiving elements spaced apart from these noise sources.

What is claimed is:

1. An antenna array system for Navigation Systems comprising a set of receiving elements, each receiving element comprising at least one antenna or more antennas, the antennas being designed for receiving electro-magnetic signals of at least one certain wavelength, whereby at least two receiving elements of said set of receiving elements are located in distance to each other of at least said one certain wavelength, whereby the signals received by said receiving elements are processed by at least one signal processing unit to thereby determine a location related information.

2. The antenna array system according to claim 1, wherein the system comprises a preprocessing unit for each receiving element.

3. The antenna array system according to claim 1, wherein at least two receiving elements each comprises at least two antennas, whereby the antennas of said receiving elements are arranged such that the antennas thereof form a planar configuration, whereby the planar configuration of said at least two receiving elements form a planar configuration as well.

4. The antenna array system according to claim 1, wherein at least two receiving elements each comprises at least two antennas, whereby the antennas of said receiving elements are arranged such that the antennas thereof form a planar configuration, whereby the planar configuration of said at least two receiving elements form a planar configuration as well, whereby juxtaposition of two antennas within an receiving element defines a respective direction, whereby a direction of a first receiving element and a direction of a second receiving element form an angle of more than 0° and less than 180°, preferably within the range of 70°-110°.

5. The antenna array system according to claim 1, wherein the antenna arrays provide their respective signals towards said at least one processing unit in a predetermined Phase- and or Amplitude-relationship.

6. The antenna array system according to claim 2, wherein said preprocessing unit perform pre-processing based on relative positioning of a concerned array within the system.

7. The antenna array system according to claim 1, wherein the antennas are dimensioned for reception of GNSS-Signals and/or signals of terrestrial radio communications, navigation, surveillance or broadcast systems.

8. Vehicle comprising an antenna array system according to claim 1.

9. The vehicle according to claim 8, wherein the vehicle is a ground vehicle, an aircraft or a water-based vehicle.

10. The vehicle according to claim 8, wherein the vehicle is a ground vehicle, whereby said antenna arrays are located in one or more bumpers of the vehicle.

11. The vehicle according to claim 8, wherein the vehicle is a ground vehicle, whereby said antenna arrays are located in one or more outside rearview mirrors of the vehicle.

12. A method for operation of an Antenna array system for Navigation Systems comprising a set of receiving elements, each receiving element comprising at least one antenna or more antennas, the antennas being designed for receiving electro-magnetic signals of at least a certain wavelength, whereby at least two receiving elements of said set of receiving elements are located in distance to each other of at least said one certain wavelength, whereby the signals received by said receiving elements are processed by at least one central signal processing unit to thereby determine a location related information, the method comprising at least one or multiple of the following steps:
Receiving analogue signals via antennas of said receiving elements,
Converting said analogue signals in digital representations,
Subjecting the digital representations to interference mitigation,
Correlating said digital representations after interference mitigation with position specific Pseudo-Random-Noise and subjecting the results to a beamforming algorithm for coherent mixing,
Determining a location related information.

13. The method according to claim 12, wherein the interference mitigation algorithm is a pre-whitening.

14. A method for operation of an Antenna array system for Navigation Systems comprising a set of receiving elements, each receiving element comprising at least one antenna or more antennas, the antennas being designed for receiving electro-magnetic signals of at least a certain wavelength, whereby at least two receiving elements of said set of receiving elements are located in distance to each other of multiple wavelengths, whereby the signals received by said receiving elements are processed by at least one signal processing unit to thereby determine a location related information, the method comprising at least one or multiple of the following steps:
Receiving analogue signals via antennas of said receiving elements,
Converting said analogue signals in digital representations.
Correcting either the digital representations or the analogue signals such that amplitude differences and/or phase differences are reduced with respect to one digital representation to another digital representation,
Subjecting the digital representations to interference mitigation,
Correlating said digital representations after interference mitigation with position specific Pseudo-Random-Noise and subjecting the results to a beamforming algorithm for coherent mixing,
Determining a location related information.

15. The method according to claim 14, wherein the step of correcting is performed with respect to the digital representations.

16. The method according to claim 14, further comprising the steps of:
Determination of the array attitude
Detection and mitigation of multipath signals
Detection and mitigation of spoofing signals.
